(19) United States
(12) Patent Application Publication
(10) Pub. No.: US 2019/0028538 A1
(43) Pub. Date: Jan. 24, 2019

(54) METHOD, APPARATUS, AND SYSTEM FOR CONTROLLING SERVICE TRAFFIC BETWEEN DATA CENTERS

(71) Applicant: ALIBABA GROUP HOLDING LIMITED, George Town (KY)

(72) Inventors: Ziang CHEN, Hangzhou (CN); Jiaming WU, Hangzhou (CN); Hao WU, Hangzhou (CN); Zhuo CHEN, Hangzhou (CN); Qian WANG, Hangzhou (CN); Haisheng LEI, Hangzhou (CN); Guangtao DONG, Hangzhou (CN); Wangwang LIU, Hangzhou (CN); Pengfei LI, Hangzhou (CN)

(73) Assignee: ALIBABA GROUP HOLDING LIMITED

(21) Appl. No.: 16/141,844

(22) Filed: Sep. 25, 2018

Related U.S. Application Data
(63) Continuation of application No. PCT/CN2017/077807, filed on Mar. 23, 2017.

(30) Foreign Application Priority Data
Mar. 25, 2016 (CN) 201610177065.2

(51) Int. Cl. H04L 29/08

(52) U.S. Cl. CPC H04L 67/1008; H04L 67/1034

(57) ABSTRACT

There is provided a method, an apparatus, and a system for controlling service traffic between data centers. According to one exemplary method, an active data center and a standby data center that have a mutually redundant relationship are provided. At least one load balancing device is deployed in each of the active data center and the standby data center. In the case of switching from the active data center to the standby data center, service traffic transmitted to the active data center is guided to the standby data center, and the load balancing device in the standby data center allocates the service traffic.

### CROSS-REFERENCE TO RELATED APPLICATION

The present application claims priority to International Application No. PCT/CN2017/077807, filed on Mar. 23, 2017, which claims priority to Chinese Patent Application No. 201610177065.2, filed on Mar. 25, 2016, both of which are incorporated herein by reference in their entireties.

### TECHNICAL FIELD

The present disclosure relates to the field of load balancing technologies, and in particular, to a method, an apparatus, and a system for controlling service traffic between data centers.

### BACKGROUND

Computer technologies have entered the network-centered era. The fast-growing Internet, with the rapid increase in the number of users and the amount of network traffic, increasingly imposes heavy burden on network servers. As a result, network servers need to have a higher expandability and availability. An Internet data center (IDC) has emerged to solve this problem.

The IDC is network-based and is a part of basic network resources of the Internet. The IDC provides a high-end data transmission service and a high-speed access service. The IDC provides both fast and secure networks and services of network management solutions such as server supervision and traffic monitoring.

An Internet service cluster in the IDC has implemented various redundancies for power, networks, servers, and the like. A single cluster can prevent a failure from affecting an external service for a user. The failure may be a single-path power failure, a one-sided network failure, a service hardware failure, an unexpected system breakdown, or even a sudden power failure, a sudden network interruption or a sudden breakdown of an entire (one) cabinet. However, a failure in a wider range, e.g., a failure of an entire data center becoming unavailable, cannot be solved by using internal redundancies for Internet services in the IDC.

No effective solution has been proposed to solve the technical problem in the conventional art in which an Internet service in an IDC is interrupted when a data center fails and becomes unavailable.

### SUMMARY

Embodiments of the present disclosure provide a method, an apparatus, and a system for controlling service traffic between data centers to attempt to solve the technical problem in the conventional art in which an Internet service in an IDC is interrupted when a data center fails and becomes unavailable.

In accordance with some embodiments of the present disclosure, a method for controlling service traffic between an active data center and a standby data center, the standby data center deploying at least one load balancing device, is provided. The method includes performing a switching from the active data center to the standby data center. The method also includes guiding service traffic transmitted to the active data center to the standby data center, wherein the guided service traffic is allocated by the at least one load balancing device in the standby data center.

In accordance with some embodiments of the present disclosure, a system for controlling service traffic between data centers is further provided. The system includes an active data center having at least one load balancing device configured to receive and forward service traffic, and a standby data center having at least one load balancing device. The active data center and the standby data center are configured to be switchable. Service traffic is guided to the standby data center in response to a switch from the active data center to the standby data center, and the at least one load balancing device in the standby data center allocates the service traffic.

In accordance with some embodiments of the present disclosure, an apparatus for controlling service traffic between data centers is further provided. The apparatus includes a control module configured to, in response to a switch from an active data center to a standby data center having at least one load balancing device, guide service traffic transmitted to the active data center to the standby data center, such that the at least one load balancing device in the standby data center allocates the service traffic.

In accordance with some embodiments of the present disclosure, there is provided a non-transitory computer-readable storage medium storing a set of instructions that is executable by one or more processors of an electronic device to cause the electronic device to perform a method for controlling service traffic between an active data center and a standby data center, the standby data center deploying at least one load balancing device. The method includes performing a switching from the active data center to the standby data center. The method also includes guiding service traffic transmitted to the active data center to the standby data center. The guided service traffic is allocated by the at least one load balancing device in the standby data center.

### BRIEF DESCRIPTION OF THE DRAWINGS

The accompanying drawings referred to herein are used to provide further understanding of the present disclosure, and constitute a part of the present disclosure. Exemplary embodiments of the present disclosure and descriptions of the exemplary embodiments are used to explain the present disclosure, and are not intended to constitute inappropriate limitations to the present disclosure. In the accompanying drawings:

FIG. 1 is a block diagram of an exemplary computer terminal used for a method for controlling service traffic between data centers according to some embodiments of the present disclosure;

FIG. 2 is a flowchart of an exemplary method for controlling service traffic between data centers according to some embodiments of the present disclosure;

FIG. 3 is a schematic diagram of an exemplary guidance of service traffic between data centers according to some embodiments of the present disclosure;

FIG. 4 is a schematic diagram of an exemplary deployment mode of layer-4 load balancing according to some embodiments of the present disclosure;

FIG. 5 is a schematic diagram of an exemplary deployment mode of layer-7 load balancing according to some embodiments of the present disclosure;

FIG. 6 is an interaction diagram of an exemplary optional method for controlling service traffic between data centers according to some embodiments of the present disclosure;

FIG. 7 is a schematic diagram of an exemplary apparatus for controlling service traffic between data centers according to some embodiments of the present disclosure;

FIG. 8 is a schematic diagram of an exemplary optional apparatus for controlling service traffic between data centers according to some embodiments of the present disclosure;

FIG. 9 is another schematic diagram of an exemplary optional apparatus for controlling service traffic between data centers according to some embodiments of the present disclosure;

FIG. 10 is yet another schematic diagram of an exemplary optional apparatus for controlling service traffic between data centers according to some embodiments of the present disclosure;

FIG. 11 is yet another schematic diagram of an exemplary optional apparatus for controlling service traffic between data centers according to some embodiments of the present disclosure;

FIG. 12 is a schematic diagram of an exemplary system for controlling service traffic between data centers according to some embodiments of the present disclosure;

FIG. 13 is a schematic diagram of an exemplary optional system for controlling service traffic between data centers according to some embodiments of the present disclosure;

FIG. 14 is another schematic diagram of an exemplary optional system for controlling service traffic between data centers according to some embodiments of the present disclosure;

FIG. 15 is yet another schematic diagram of an exemplary optional system for controlling service traffic between data centers according to some embodiments of the present disclosure;

FIG. 16 is yet another schematic diagram of an exemplary optional system for controlling service traffic between data centers according to some embodiments of the present disclosure; and

FIG. 17 is a block diagram of an exemplary computer terminal according to some embodiments of the present disclosure.

### DETAILED DESCRIPTION

In order to better understand the solutions in the present disclosure, the technical solutions in some of the embodiments of the present disclosure will be described with reference to the accompanying drawings. It is apparent that the described embodiments are merely a part of rather than all the embodiments of the present disclosure. In addition to the embodiments described herein, all other embodiments derived by those of ordinary skill in the art without creative effort shall fall within the protection scope of the present disclosure.

It is noted that, terms such as “first” and “second” in the specification, the claims, and the accompanying drawings of the present disclosure are used to distinguish between similar objects modified by these terms, and are not necessarily used to describe a specific sequence or order. It is understood that the terms used in such a manner can be exchanged in appropriate cases, so that the embodiments of the present disclosure described herein can be implemented in sequences other than those shown or described herein. Moreover, terms such as “include” and “have” and the like are intended to cover non-exclusive inclusion. For example, a process, method, system, apparatus, or device including a series of steps or units is not limited to those listed steps or units, but can include other steps or units that are not listed or are inherent to the process, method, apparatus, or device.

As described herein, it is easily noted that the active data center and the standby data center have a mutually redundant relationship, and data in the active data center can be synchronized to the standby data center in real time. When the active data center fails and becomes unavailable, switching can be performed from the active data center to the standby data center, such that the load balancing device in the standby data center allocates the traffic. Therefore, by means of the solution provided in the embodiments of the present disclosure, once a failure, such as a catastrophic failure, occurs in a data center (e.g., an active data center), service traffic can be quickly migrated to another data center (e.g., a standby data center), and service functions can be restored to the another data center within a short time. Thus, corresponding waiting time of users can be reduced, network data processing capability can be enhanced, and flexibility and availability of the network can be improved.

Accordingly, the solutions provided in the present disclosure can solve the technical problem in the conventional art in which an Internet service in an IDC is interrupted when a data center fails and becomes unavailable.

According to some embodiments of the present disclosure, an exemplary method for controlling service traffic between data centers is provided. It is noted that, steps shown in the flowchart of the accompanying drawings can be performed in a computer system as a set of computer executable instructions. Moreover, although an order may be shown in the flowchart, in some cases, the shown or described steps can be performed in an order different from that described herein.

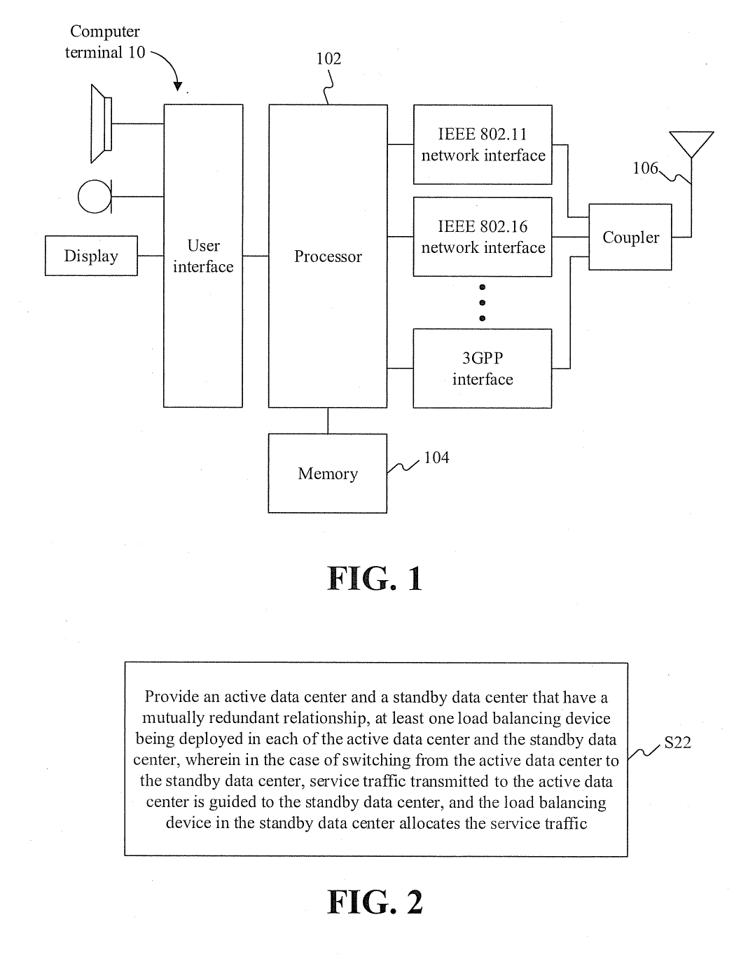

The method embodiments provided in the present disclosure can be performed in a mobile terminal, a computer terminal, or a similar arithmetic device. A computer terminal is taken as an example for a method of the some embodiments to be carried out. FIG. 1 is a block diagram of an exemplary computer terminal used for a method for controlling service traffic between data centers according to some embodiments of the present disclosure. As shown in FIG. 1, a computer terminal 10 can include one or more processors 102 (merely one is shown in the figure). Processor 102 may include, but is not limited to, a processing apparatus, for example, a microprocessor such as an MCU or a programmable logic device such as an FPGA. Computer terminal 10 can also include a memory 104 configured to store data and a transmission apparatus 106 having a communication function. It is understood that the structure shown in FIG. 1 is merely exemplary, and is not intended to be limiting. For example, computer terminal 10 may further include more or fewer components than those shown in FIG. 1 or have a configuration different from that shown in FIG. 1.

Memory 104 may be configured to store programs and modules of software applications, e.g., program instructions or a module corresponding to the method for controlling service traffic between data centers disclosed herein. Processor 102 executes software programs and modules stored in memory 104 to perform various functions and data processing, for example, to implement a method for controlling service traffic between data centers. Memory 104 may include a high-speed random access memory, and may further include a non-volatile memory, e.g., one or more magnetic storage apparatuses, flash memories, or other non-volatile solid-state memories. In some examples, memory 104 may further include memories remotely disposed with respect to processor 102, and the remote memories may be connected to computer terminal 10 through a network. Examples of the network include, but are not limited to, the Internet, an Intranet, a local area network, a mobile telecommunications network, and their combinations.

Transmission apparatus 106 is configured to receive or send data via a network. A specific example of the network may include a wireless network provided by a communications service provider for the computer terminal 10. In an example, transmission apparatus 106 includes a Network Interface Controller (NIC), which may be connected to another network device via a base station to communicate with the Internet. For example, transmission apparatus 106 may include a Radio Frequency (RF) module, which is configured to communicate with the Internet in a wireless manner.

In the foregoing environment, the present disclosure provides an exemplary method for controlling service traffic between data centers shown in FIG. 2. FIG. 2 is a flowchart of an exemplary method for controlling service traffic between data centers according to some embodiments of the present disclosure. The method shown in FIG. 2 may include step S22.

In step S22, an active data center and a standby data center that have a mutually redundant relationship are provided. At least one load balancing device is deployed in each of the active data center and the standby data center. In the case of switching from the active data center to the standby data center, service traffic transmitted to the active data center is guided to the standby data center, and the load balancing device in the standby data center allocates the service traffic.

Specifically, the active data center and the standby data center in the above step may be two data centers (IDC rooms) in the same region. For example, a data center with a high priority in a data center cluster may be set as the active data center, and a data center with a low priority may be set as the standby data center. After switching is performed from the active data center to the standby data center, data in the active data center may be migrated to the standby data center. A storage device in the active data center communicates with a storage device in the standby data center, and data in the storage device in the active data center is synchronized to the storage device in the standby data center in real time. The standby data center creates a corresponding service network and a service server according to network information of the service server, network device configuration information, and service server information. Service traffic transmitted to the active data center is guided to the standby data center. Specifically, the load balancing device in the active data center may perform address and port conversion on service traffic sent by a user and send the service traffic sent by the user to the load balancing device in the standby data center. The load balancing device may forward the service traffic to a target server according to a load balancing algorithm.

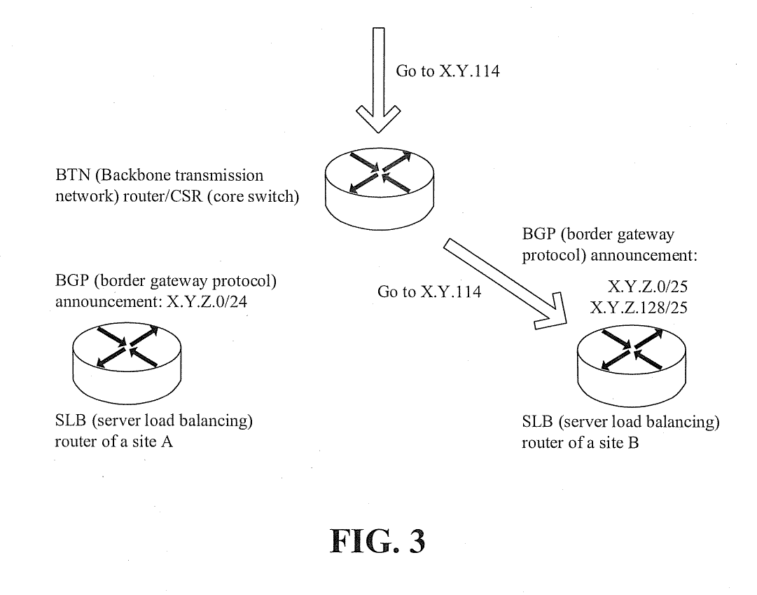

FIG. 3 is a schematic diagram of an exemplary guidance of service traffic between data centers according to some embodiments of the present disclosure. For example, the foregoing embodiments of the present disclosure are described by taking an application scenario shown in FIG. 3 as an example. For an Internet service in an IDC, an IP address of the Internet service in the IDC in the same region may be simultaneously announced (published by border gateway protocol (BGP) routing) to have different “priorities” in two rooms. BGP is used to exchange routing information between different autonomous systems (ASs). When two ASs exchange routing information, each AS designates a node running the BGP to represent the AS to exchange routing information with the other AS.

As shown in FIG. 3, a BGP route announcement of a server load balancing (SLB) router of a site A is X.Y.Z.0/24. SLB can involve setting a virtual service address (IP address), allowing resources of a plurality of cloud servers (elastic compute service (ECS)) located in the same region to be virtualized into a high-performance and highly-available application service pool. Network requests from clients are distributed to a cloud server pool according to an application-specific manner.

A BGP route announcement of an SLB router of a site B is X.Y.Z.0/25, X.Y.Z.128/25. A data center with a high priority is an active data center, which may be the SLB router of the site A in FIG. 3. A data center with a low priority is a standby data center, which may be the SLB router of the site B in FIG. 3. A mutually redundant relationship is implemented between the active data center and the standby data center. In a normal case, ½ VIPs with high priorities run in two different IDCs. In the case of switching from the active data center to the standby data center, service traffic transmitted to the active data center can be guided to the standby data center. A load balancing device in the standby data center allocates the received service traffic to a corresponding service server by using a load balancing algorithm.

In the solution disclosed in the above embodiments of the present disclosure, an active data center and a standby data center have a mutually redundant relationship. At least one load balancing device is deployed in each of the active data center and the standby data center. In the case of switching from the active data center to the standby data center, service traffic transmitted to the active data center can be guided to the standby data center in the solution, such that the load balancing device in the standby data center allocates the service traffic, thus implementing migration of the service traffic. This type of service migration involves migrating services from one physical data center (DC) to another physical DC at a different place. All resources of the entire service are migrated during the migration.

It is noted that the active data center and the standby data center have a mutually redundant relationship, and data in the active data center can be synchronized to the standby data center in real time. When the active data center fails and becomes unavailable, switching can be performed from the active data center to the standby data center, such that the load balancing device in the standby data center allocates the traffic. Therefore, by means of the solution provided in the embodiments of the present disclosure, when a failure, such as a catastrophic failure, occurs in a data center (e.g., an active data center), service traffic can be quickly migrated to another data center (e.g., a standby data center), and service functions can be restored to the another data center within a short time. Thus, corresponding waiting time of users can be reduced, network data processing capability can be enhanced, and flexibility and availability of the network can be improved.

Accordingly, the solution of the foregoing embodiments provided in the present disclosure can tackle the technical problem in the conventional art in which an Internet service in an IDC is interrupted when a data center fails and becomes unavailable.

In the foregoing embodiments of the present disclosure, the method may further include step S24. In step S24, the active data center is monitored by an intermediate router. If it is detected that the active data center is in an unavailable state, switching is performed from the active data center to the standby data center.

Specifically, the unavailable state can include at least one of the following states: a power-off state, a failed state, an intrusion state, and an overflow state.

In an optional solution, when detecting that the active data center is unavailable, the intermediate router may deliver a data center switching instruction. The active data center may lower its own priority after the storage device in the active data center receives the data center switching instruction, and the standby data center may raise its own priority after the storage device in the standby data center receives the data center switching instruction, such that switching can be performed from the active data center to the standby data center.

For example, the foregoing embodiments of the present disclosure are described by still taking the application scenario shown in FIG. 3 as an example. For an Internet service in an IDC, a data center usually having a “high priority” (which may be the SLB router of the site A in FIG. 3) provides a service for a client. When the data center becomes unavailable, the border routing protocol BGP converges quickly (e.g., within 180 seconds in the worst case, and within 30 seconds in a normal case). In this case, a data center having a “low priority” keeps serving the user in place of the failed data center having a “high priority.” When a single data center is unavailable, for example, when the active data center is unavailable or fails, fail-over migration may be performed to copy data in the active data center to the standby data center, and switching is performed from the active data center to the standby data center, such that the standby data center allocates service traffic.

By means of the solution provided in the foregoing step S24, when the active data center is unavailable, switching is performed from the active data center to the standby data center. Therefore, switching is performed from the active data center to the standby data center when the active data center fails and becomes unavailable, such that the standby data center provides services for users.

In the foregoing embodiments of the present disclosure, before switching is performed from the active data center to the standby data center in step S24, the method may further include step S26. In step S26, data is synchronized in real time between the active data center and the standby data center.

Specifically, the active data center and the standby data center have a mutually redundant relationship. Data in the active data center can be copied to the standby data center in real time. Therefore, when the active data center (or the standby data center) fails, the standby data center (or the active data center) can take over an application within a short time, thus ensuring continuity of the application.

In an optional solution, to ensure that the load balancing device in the standby data center can allocate traffic transmitted to the active data center after switching is performed from the active data center to the standby data center, data synchronization between the active data center and the standby data center is to be ensured. The storage device in the active data center may communicate with the storage device in the standby data center, and data is synchronized in real time between the active data center and the standby data center, thus ensuring data synchronization between the two data centers.

For example, the foregoing embodiments of the present disclosure are described by still taking the application scenario shown in FIG. 3 as an example. An active data center (which may be the SLB router of the site A in FIG. 3) may communicate with a standby data center (which may be the SLB router of the site B in FIG. 3), and data in the two storage devices is synchronized in real time. Moreover, in the case of switching from the active data center to the standby data center, the data in the active data center is copied to the standby data center, thus ensuring data synchronization between the standby data center and the active data center.

By means of the solution provided in the foregoing step S26, data can be synchronized between the active data center and the standby data center in real time. Therefore, after switching is performed from the active data center to the standby data center, the load balancing device in the standby data center can allocate service traffic transmitted to the active data center, thus ensuring the availability of a service of a user.

In the above embodiments of the present disclosure, the load balancing device may include one or more types as follows: a layer-3 load balancing device, a layer-4 load balancing device, a layer-5 load balancing device, a layer-6 load balancing device, and a layer-7 load balancing device.

Specifically, the layer-3 load balancing device in the foregoing step is based on an IP address. A request can be received by using a virtual IP address, and the request is then allocated to a real IP address. The layer-4 load balancing device is based on an IP address and port. A request can be received by using a virtual IP address and port, and the request is then allocated to a real server. The layer-7 load balancing device is based on application layer information such as a uniform resource locator (URL), which represents a location of a resource that is available on the Internet and a method of accessing the resource. A request can be received by using a virtual URL address or host name, and the request is then allocated to a real server.

In an optional solution, the layer-4 load balancing device can publish a layer-3 IP address (VIP) and add a layer-4 port number to determine traffic on which load balancing processing is to be performed. The traffic on which load balancing processing is to be performed is forwarded to a back-end server, and identification information of the back-end server to which the traffic is forwarded is stored, thus ensuring that all subsequent traffic is processed by the same server.

In another optional solution, based on the layer-4 load balancing device, the layer-7 load balancing device may further be provided with application layer features such as a URL address, an HTTP protocol, Cookie, and other information to determine the traffic on which load balancing processing is to be performed.

In the foregoing embodiments of the present disclosure, when the load balancing device includes a layer-4 load balancing device, allocating service traffic by the load balancing device in the standby data center, such as step S22, may include steps S222 and S224.

In step S222, the layer-4 load balancing device in the standby data center selects a target server according to a scheduling strategy.

In step S224, the layer-4 load balancing device allocates the service traffic to the target server through a Linux virtual server (LVS) cluster, which may receive data stream from an uplink switch through equal-cost multi-path (ECMP) routing and may forward the data stream accordingly.

Specifically, the scheduling strategy may include, but is not limited to, a polling manner, a URL scheduling strategy, a URL hash scheduling strategy, or a consistency hash scheduling strategy. The layer-4 load balancing device can send data traffic to an LVS cluster through ECMP routing, and the LVS cluster forwards the data traffic to the target server.

In an optional solution, the layer-4 load balancing device is connected to a plurality of servers. After a request packet sent by a user of a first network is received, address (e.g., including a source address and a destination address) and port conversion may be performed on the request packet to generate a request packet of a second network. A target server is determined from among the plurality of servers by using a scheduling strategy, and the LVS cluster sends the request packet of the second network to the corresponding target server. The target server may return, by using a source address mapping manner, a returned response packet of the second network to the layer-4 load balancing device. After receiving the response packet of the second network, the layer-4 load balancing device performs address and port conversion on the response packet of the second network to generate a response packet of the first network, and returns the response packet of the first network to the user.

Here, it is noted that the request packet of the first network and the response packet of the first network can be packets of the same network type. The request packet of the second network and the response packet of the second network can be packets of the same network type.

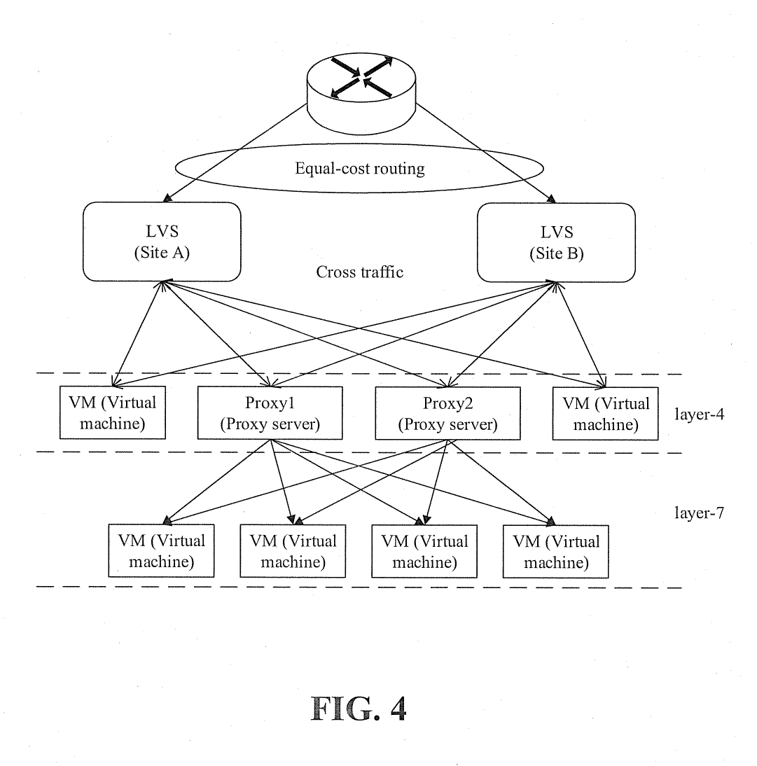

FIG. 4 is a schematic diagram of an exemplary deployment mode of layer-4 load balancing according to some embodiments of the present disclosure. For example, the foregoing embodiments of the present disclosure are described by taking an application scenario shown in FIG. 4 as an example. For a layer-4 user in a public cloud with SLB, in a layer-4 area, a virtual machine (VM) represents a corresponding user instance. A proxy server represents a proxy component of the SLB, and can indicate a layer-4 load balancing device. SLB in a data center can guide service traffic by performing health check. In a normal state, one piece of monitored traffic is forwarded by only one data center. In the case of switching from an active data center (which may be a site A in FIG. 4) to a standby data center (which may be a site B in FIG. 4), a layer-4 load balancing device in the standby data center selects a target server according to a scheduling strategy, and allocates service traffic to the target server through an LVS cluster.

By means of the solution provided in the foregoing steps S222 and S224, a load balancing device can determine a target server by using a scheduling strategy, and allocate traffic to the target server through an LVS cluster. Thus, availability of a user service can be ensured, and the stability of a load balancing service can be improved.

In the foregoing embodiments of the present disclosure, the scheduling strategy may include determining the target server by checking online states or resource usage of a plurality of back-end service servers. A control server in the standby data center can configure a scheduling strategy. When any data center is allowed to access each back-end service group, cross traffic may be generated when the LVS cluster forwards the service traffic in the plurality of back-end service servers.

In an optional solution, to ensure that more service requests can be allocated to a server that processes fewer service requests or that a failed server can stop receiving a service request until the failure is fixed, an optimal target server can be determined by performing the following action. The action can include determining whether there is a failed server in a plurality of back-end service servers by checking online states of the service servers. The action can also include determining the number of service requests processed by each service server by checking the resource usage of the plurality of back-end service servers.

For example, the foregoing embodiments of the present disclosure are described by still taking the application scenario shown in FIG. 4 as an example. For a layer-4 user in a public cloud with SLB, in a layer-4 area, a VM may represent a corresponding user instance, and all instances are visible to all data centers. Therefore, cross traffic may occur when the LVS cluster forwards the service traffic.

By means of the foregoing solution, a target server can be determined by checking online states or resource usage of a plurality of back-end service servers, such that the plurality of back-end service servers can better accomplish tasks together. Thus, existing bottlenecks of uneven distribution of network load and long response time due to data traffic congestion can be eliminated or avoided.

In the foregoing embodiments of the present disclosure, when the load balancing device includes a layer-7 load balancing device, allocating service traffic by the load balancing device in the standby data center, such as step S22, may include steps S226 and S228.

In step S226, the layer-7 load balancing device in the standby data center selects a target server according to a scheduling strategy.

In step S228, the layer-7 load balancing device allocates the service traffic to the target server through an LVS cluster.

Specifically, the scheduling strategy of the layer-7 load balancing device may be the same as or different from the scheduling strategy of the layer-4 load balancing device. The layer-7 load balancing device can send data traffic to an LVS cluster through ECMP routing, and the LVS cluster forwards the data traffic to the target server.

In an optional solution, the layer-7 load balancing device is connected to a plurality of servers. After receiving a request packet sent by a user of a first network, the layer-7 load balancing device can establish a connection with a client terminal through a proxy server to receive a packet of real application layer content sent by the client terminal, and determine a target server according to a specific field (e.g., a header of an HTTP packet) in the packet and according to a scheduling strategy.

Here, it is noted that the load balancing device may be more similar to a proxy server in this case. The load balancing device can establish a TCP connection respectively with a front-end client terminal and a back-end server. Therefore, the layer-7 load balancing device may have a higher requirement and a lower processing capability than the layer-4 load balancing device.

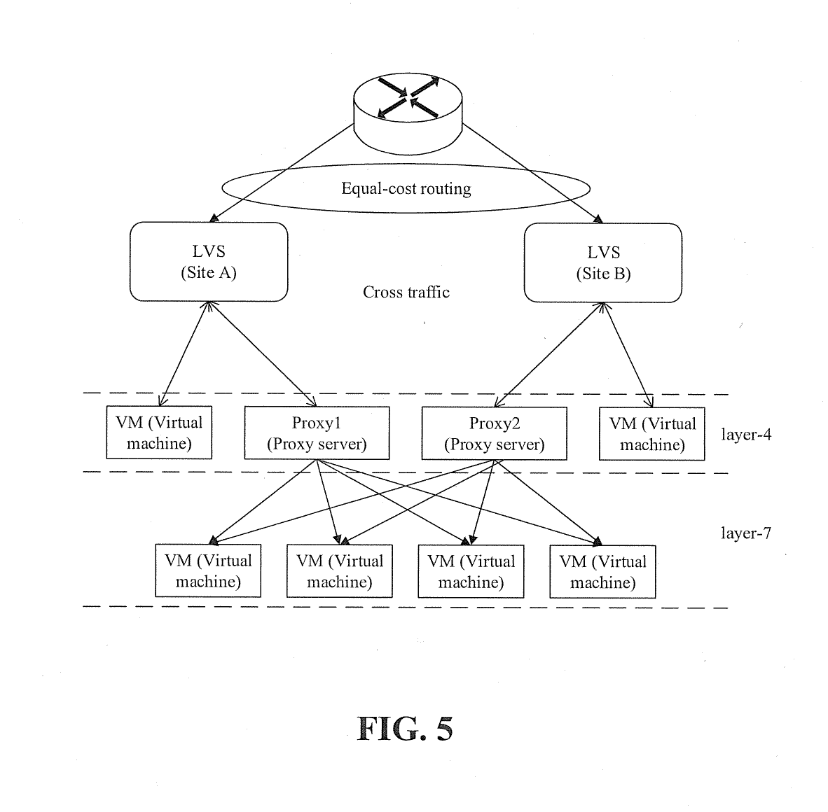

FIG. 5 is a schematic diagram of an exemplary deployment mode of layer-7 load balancing according to some embodiments of the present disclosure. For example, the foregoing embodiments of the present disclosure are described by taking an application scenario shown in FIG. 5 as an example. For a layer-7 user in a public cloud with SLB, in a layer-4 area, a proxy server represents a proxy component of the SLB, and can indicate a layer-7 load balancing device. SLB in a data center can guide service traffic by performing health check. In a normal state, one piece of monitored traffic is forwarded by only one data center. In the case of switching from an active data center (which may be a site A in FIG. 5) to a standby data center (which may be a site B in FIG. 5), a layer-7 load balancing device in the standby data center selects a target server according to a scheduling strategy, and allocates service traffic to the target server through an LVS cluster.

By means of the solution provided in the foregoing steps S226 and S228, a load balancing device can determine a target server by using a scheduling strategy, and allocate traffic to the target server through an LVS cluster. Thus, availability of a user service can be ensured, a failure in an application layer can be avoided, and the stability of a load balancing service can be improved.

In the foregoing embodiments of the present disclosure, the scheduling strategy may include determining the target server by checking online states or resource usage of a plurality of back-end service servers. A control server in the standby data center may configure a scheduling strategy. When only the current standby data center is allowed to access a plurality of back-end service groups, each LVS in the LVS cluster is allocated with at least one back-end service server that has a connection relationship and the allocated back-end service servers may differ across the LVSs, such that no cross traffic is generated when the plurality of back-end service servers forward the service traffic.

In an optional solution, to ensure that more service requests can be allocated to a server that processes fewer service requests or that a failed server can stop receiving a service request until the failure is fixed, an optimal target server can be determined by performing the following action. The action can include determining whether there is a failed server in a plurality of back-end service servers by checking online states of the service servers. The action can also include determining the number of service requests processed by each service server by checking the resource usage of the plurality of back-end service servers.

For example, the foregoing embodiments of the present disclosure are described by still taking the application scenario shown in FIG. 5 as an example. For a layer-7 user in a public cloud with SLB, in a layer-4 area, a proxy server represents a proxy component of the SLB, and all instances thereof are visible to all data centers. Therefore, cross traffic may occur when the LVS cluster forwards the service traffic, and a proxy component in a data center is only visible to SLB in the current data center. As such, it is avoided that traffic of the layer-7 user crosses into the L4 area to increase an unnecessary delay.

By means of the foregoing solution, a target server can be determined by checking online states or resource usage of a plurality of back-end service servers, such that the plurality of back-end service servers can accomplish tasks together. Thus existing bottlenecks of uneven distribution of network load and long response time due to data traffic congestion can be eliminated or avoided.

In the foregoing embodiments of the present disclosure, a control server in a standby data center can configure an RDS database corresponding to the current data center, such that no cross traffic is generated when the RDS database stores the service traffic in the case in which only the current standby data center is allowed to access the RDS database.

For example, the foregoing embodiments of the present disclosure are described by taking the application scenario shown in FIG. 5 as an example. For a user of an RDS, in a layer-4 area, a VM represents a database of the RDS. The RDS is sensitive to a delay, and therefore an identification (ID) of a data center in which the database of the RDS is located is designated during configuration, such that an SLB configuration system ensures that the ID of the data center is only visible to an SLB in the current data center. Thus, cross traffic can be avoided, and an unnecessary delay can be reduced.

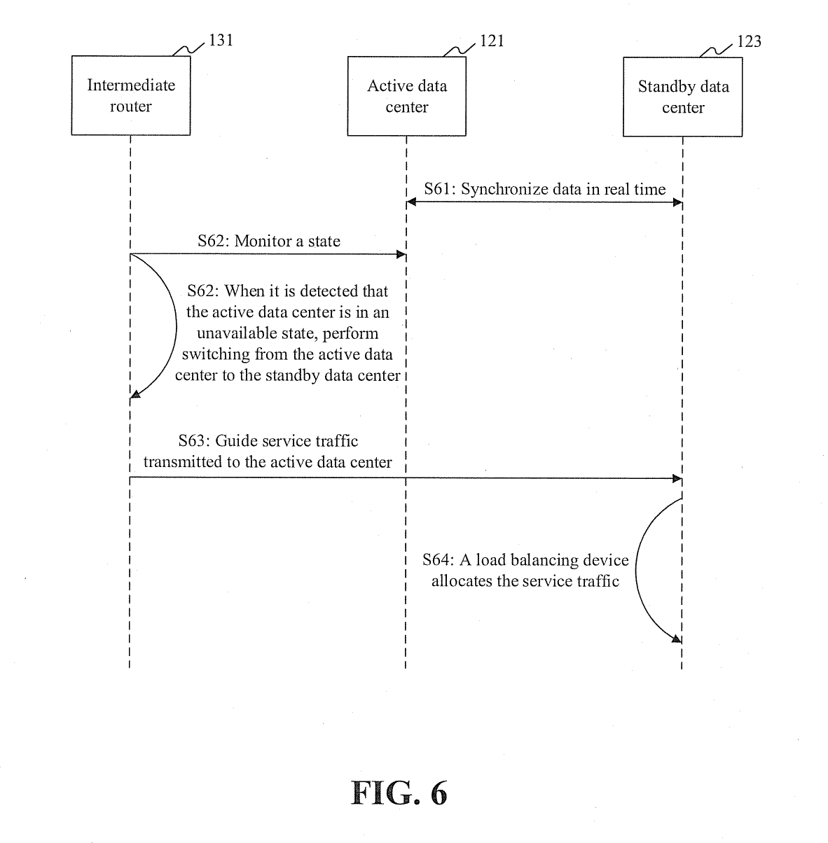

Additional embodiments of the present disclosure are introduced in the following with reference to FIG. 3, FIG. 4, FIG. 5, and FIG. 6.

As shown in FIG. 6, as an application scenario, an exemplary optional method for controlling service traffic between data centers is provided according to some embodiments of the disclosure. The method may include steps S61 to S64.

In step S61, an active data center 121 synchronizes data with a standby data center 123 in real time. Optionally, the active data center and the standby data center may have a mutually redundant relationship, and data in the active data center can be copied to the standby data center in real time.

In step S62, an intermediate router 131 monitors a state of the active data center 121 and performs switching from the active data center to the standby data center when detecting that the active data center is in an unavailable state. Optionally, when detecting that the active data center is in a power-off state, a failed state, an intrusion state, or an overflow state, the intermediate router determines that the active data center is in an unavailable state, lowers the priority of the active data center, and raises the priority of the standby data center to perform switching from the active data center to the standby data center.

In step S63, intermediate router 131 guides service traffic transmitted to the active data center to standby data center 123. Optionally, a load balancing device in the active data center can perform address and port conversion on service traffic sent by a user and send the service traffic sent by the user to a load balancing device in the standby data center.

In step S64, the load balancing device in standby data center 123 allocates the service traffic. Optionally, the load balancing device may include a layer-3 load balancing device, a layer-4 load balancing device, a layer-5 load balancing device, a layer-6 load balancing device, and a layer-7 load balancing device. The load balancing device may select a target server according to a scheduling strategy, and allocate the service traffic to the target server through an LVS cluster.

By means of the foregoing solution, an active data center may synchronize data with a standby data center in real time. When it is detected that the active data center is in an unavailable state, switching is performed from the active data center to the standby data center, and service traffic transmitted to the active data center is guided to the standby data center, such that a load balancing device in the standby data center allocates the service traffic. As a result, when the data center fails and becomes unavailable, an Internet service in an IDC can still be restored within a short time.

It is noted that, for brevity, the foregoing method embodiments are described as a series of action combinations. However, it can be understood that the present disclosure is not limited to the described action order, because some steps may be performed in another order or performed simultaneously according to the present disclosure. Moreover, it can also be understood that in the embodiments of the disclosure, certain actions and modules may not be required by the present disclosure.

Based on the foregoing descriptions of the implementation manners, it can be understood that the method for controlling service traffic between data centers according to the above embodiments may be implemented by software plus a necessary universal hardware platform. The method may also be implemented by hardware. However, in some cases, implementation by software may be a preferred implementation manner. Based on such an understanding, the technical solutions of the present disclosure may be implemented in the form of a software product. The computer software product may be stored in a storage medium (such as a Read-Only Memory (ROM)/Random Access Memory (RAM), a magnetic disk, or an optical disc), and includes instructions for instructing a terminal device (which may be a mobile phone, a computer, a server, a network device, or the like) to perform the methods in the embodiments of the present disclosure.

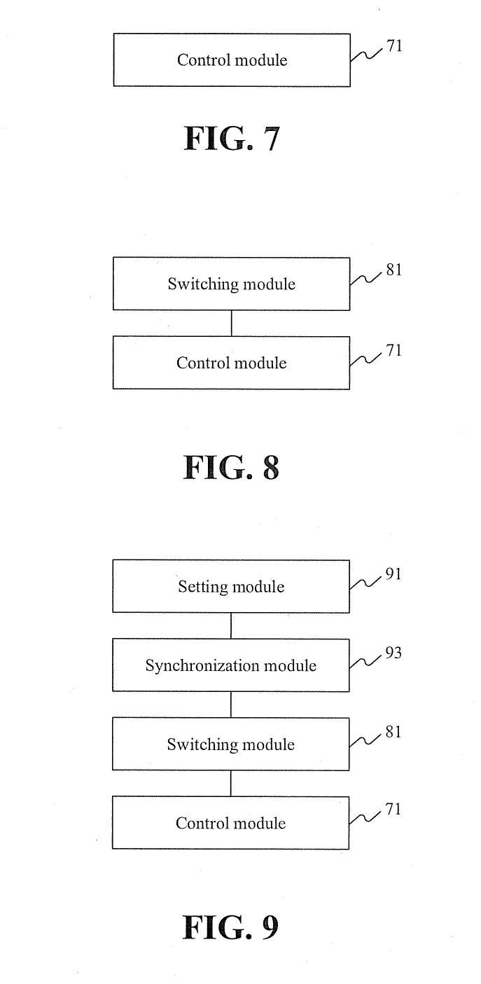

According to some embodiments of the present disclosure, an exemplary apparatus for controlling service traffic between data centers used for performing a method for controlling service traffic between data centers is further provided. As shown in FIG. 7, the apparatus includes a control module 71.

Control module 71 is configured to, in the case of switching from an active data center to a standby data center, guide service traffic transmitted to the active data center to the standby data center, such that a load balancing device in the standby data center allocates the service traffic. The active data center and the standby data center have a mutually redundant relationship, and at least one load balancing device is deployed in each of the active data center and the standby data center.

Specifically, the active data center and the standby data center in the above step may be two data centers (IDC rooms) in the same region. For example, a data center with a high priority in a data center cluster may be set as the active data center, and a data center with a low priority may be set as the standby data center. After switching is performed from the active data center to the standby data center, data in the active data center may be migrated to the standby data center. A storage device in the active data center communicates with a storage device in the standby data center, and data in the storage device in the active data center is synchronized to the storage device in the standby data center in real time. The standby data center creates a corresponding service network and a service server according to network information of the service server, network device configuration information, and service server information. Service traffic transmitted to the active data center is guided to the standby data center. Specifically, the load balancing device in the active data center may perform address and port conversion on service traffic sent by a user, and send the service traffic sent by the user to the load balancing device in the standby data center. The load balancing device may forward the service traffic to a target server according to a load balancing algorithm.

Here, it is noted that control module 71 corresponds to step S22 described above. Examples and application scenarios implemented by the module and the corresponding step may be the same as other embodiments described herein, but are not limited to in the following embodiments. For example, the module can run on computer terminal 10 as a part of the apparatus.

In the solution disclosed in some embodiments of the present disclosure, an active data center and a standby data center have a mutually redundant relationship. At least one load balancing device is deployed in each of the active data center and the standby data center. In the case of switching from the active data center to the standby data center, service traffic transmitted to the active data center can be guided to the standby data center in the solution, such that the load balancing device in the standby data center allocates the service traffic, thus implementing migration of the service traffic.

It is noted that the active data center and the standby data center have a mutually redundant relationship, and data in the active data center can be synchronized to the standby data center in real time. When the active data center fails and becomes unavailable, switching can be performed from the active data center to the standby data center, such that the load balancing device in the standby data center allocates the traffic. Therefore, by means of the solution provided in the embodiments of the present disclosure, when a failure, such as a catastrophic failure, occurs in a data center (e.g., an active data center), service traffic can be quickly migrated to another data center (e.g., a standby data center), and service functions can be restored in the another data center within a short time. Thus, corresponding waiting time of users can be reduced, network data processing capability can be enhanced, and flexibility and availability of the network can be improved.

Accordingly, the solution of the foregoing embodiments provided in the present disclosure can tackle the technical problem in the conventional art that an Internet service in an IDC is interrupted when a data center fails and becomes unavailable.

In the foregoing embodiments of the present disclosure, the apparatus may further include a switching module 81, as shown in FIG. 8.

Switching module 81 is configured to monitor the active data center, and perform switching from the active data center to the standby data center if detecting that the active data center is in an unavailable state. Specifically, the unavailable state can include at least one of the following states: a power-off state, a failed state, an intrusion state, and an overflow state.

Here, it is noted that switching module 81 corresponds to step S24 described above. Examples and application scenarios implemented by the module and the corresponding step may be the same as other embodiments described herein, but are not limited to the above embodiments. For example, the module can run on computer terminal 10 as a part of the apparatus.

By means of the foregoing solution, when the active data center is unavailable, switching is performed from the active data center to the standby data center. Therefore, switching is performed from the active data center to the standby data center when the active data center fails and becomes unavailable, such that the standby data center provides services for users.

In the foregoing embodiments of the present disclosure, the apparatus may further include a setting module 91 and a synchronization module 93, as shown in FIG. 9.

Setting module 91 is configured to set a data center having a high priority as the active data center, and to set a data center having a low priority as the standby data center. Synchronization module 93 is configured to synchronize data between the active data center and the standby data center in real time.

Specifically, the active data center and the standby data center have a mutually redundant relationship. Data in the active data center can be copied to the standby data center in real time. Therefore, when the active data center (or the standby data center) fails, the standby data center (or the active data center) can take over an application within a short time, thus ensuring continuity of the application.

Here, it is noted that synchronization module 93 corresponds to step S26 described above. Examples and application scenarios implemented by the module and the corresponding step may be the same as other embodiments described herein, but are not limited to in the above embodiments. For example, the module can run in computer terminal 10 as a part of the apparatus.

By means of the foregoing solution, data can be synchronized between the active data center and the standby data center in real time. Therefore, after switching is performed from the active data center to the standby data center, the load balancing device in the standby data center can allocate service traffic transmitted to the active data center, thus ensuring the availability of a service provided by a user.

In the above embodiments of the present disclosure, the load balancing device may include one or more types as follows: a layer-3 load balancing device, a layer-4 load balancing device, a layer-5 load balancing device, a layer-6 load balancing device, and a layer-7 load balancing device.

Specifically, the layer-3 load balancing device in the foregoing step is based on an IP address. A request can be received by using a virtual IP address, and the request is then allocated to a real IP address. The layer-4 load balancing device is based on an IP address and port. A request can be received by using a virtual IP address and port, and the request is then allocated to a real server. The layer-7 load balancing device is based on application layer information such as a URL. A request can be received by using a virtual URL address or host name, and the request is then allocated to a real server.

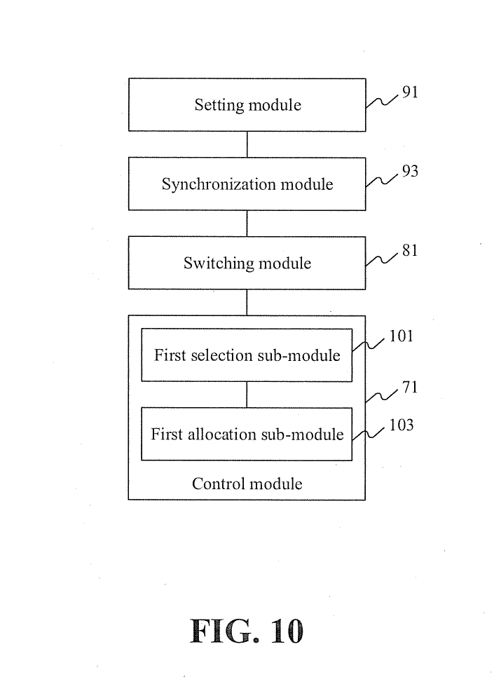

In the foregoing embodiments of the present disclosure, when the load balancing device includes a layer-4 load balancing device, control module 71 may further include a first selection sub-module 101 and a first allocation sub-module 103, as shown in FIG. 10.

First selection sub-module 101 is configured to select a target server according to a scheduling strategy. First allocation sub-module 103 is configured to allocate the service traffic to the target server through an LVS cluster.

Specifically, the scheduling strategy in the foregoing step may include, but is not limited to, a polling manner, a URL scheduling strategy, a URL hash scheduling strategy, or a consistency hash scheduling strategy. The layer-4 load balancing device can send data traffic to an LVS cluster through ECMP routing, and the LVS cluster forwards the data traffic to the target server.

Here, it is noted that first selection sub-module 101 and first allocation sub-module 103 correspond respectively to steps S222 and S224 described above. Examples and application scenarios implemented by the two modules and the corresponding steps may be the same as other embodiments described herein, but are not limited to in the above embodiments. For example, the modules can run in computer terminal 10 as a part of the apparatus.

By means of the foregoing solution, a load balancing device can determine a target server by using a scheduling strategy, and allocate traffic to the target server through an LVS cluster. Thus, availability of a user service can be ensured, and the stability of a load balancing service can be improved.

In the foregoing embodiments of the present disclosure, the scheduling strategy can include determining the target server by checking online states or resource usage of a plurality of back-end service servers. A control server in the standby data center can configure a scheduling strategy. When any data center is allowed to access each back-end service group, cross traffic may be generated when the LVS cluster forwards the service traffic in the plurality of back-end service servers.

By means of the foregoing solution, a target server can be determined by checking online states or resource usage of a plurality of back-end service servers, such that the plurality of back-end service servers can accomplish tasks together. Thus, existing bottlenecks of uneven distribution of network load and long response time due to data traffic congestion can be eliminated or avoided.

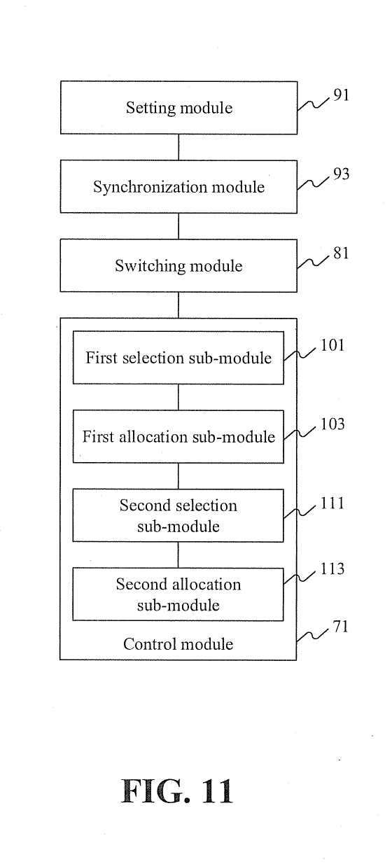

In the foregoing embodiments of the present disclosure, when the load balancing device includes a layer-7 load balancing device, control module 71 may further include a second selection sub-module 111 and a second allocation sub-module 113, as shown in FIG. 11.

Second selection sub-module 111 is configured to select a target server according to a scheduling strategy. Second allocation sub-module 113 is configured to allocate the service traffic to the target server through an LVS cluster.

Specifically, the scheduling strategy here may be the same as or different from the scheduling strategy of the layer-4 load balancing device. The layer-7 load balancing device can send data traffic to an LVS cluster through ECMP routing, and the LVS cluster forwards the data traffic to the target server.

Here, it is noted that the load balancing device may be more similar to a proxy server in this case. The load balancing device can establish a TCP connection respectively with a front-end client terminal and a back-end server. Therefore, the layer-7 load balancing device may have a higher requirement and a lower processing capability than the layer-4 load balancing device.

Here, it is noted that second selection sub-module 111 and second allocation sub-module 113 correspond respectively to steps S226 and S228 described above. Examples and application scenarios implemented by the two modules and the corresponding steps may be the same as other embodiments described herein, but are not limited to in the above embodiments. For example, the modules can run on computer terminal 10 as a part of the apparatus.

By means of the foregoing solution, a load balancing device can determine a target server by using a scheduling strategy, and allocate traffic to the target server through an LVS cluster. Thus, availability of a user service can be ensured, a failure in an application layer can be avoided, and the stability of a load balancing service can be improved.

In the foregoing embodiments of the present disclosure, the scheduling strategy may include determining the target server by checking online states or resource usage of a plurality of back-end service servers. A control server in the standby data center may configure a scheduling strategy. When only the current standby data center is allowed to access a plurality of back-end service groups, each LVS in the LVS cluster is allocated with at least one back-end service server that has a connection relationship and the allocated back-end service servers may differ across the LVSs, such that no cross traffic is generated when the plurality of back-end service servers forward the service traffic.

By means of the foregoing solution, a target server can be determined by checking online states or resource usage of a plurality of back-end service servers, such that the plurality of back-end service servers can accomplish tasks together. Thus, existing bottlenecks of uneven distribution of network load and long response time due to data traffic congestion can be eliminated or avoided.

In the foregoing embodiments of the present disclosure, a control server in a standby data center can configure an RDS database corresponding to the current data center, such that no cross traffic is generated when the RDS database stores the service traffic in the case in which only the current standby data center is allowed to access the RDS database.

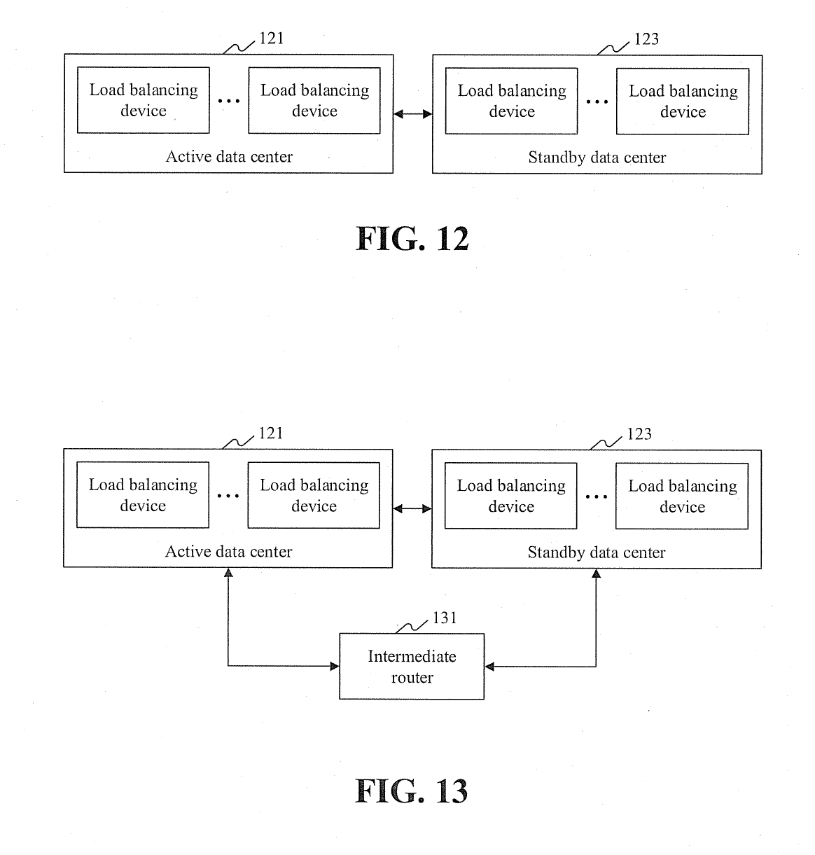

According to some embodiments of the present disclosure, an exemplary system for controlling service traffic between data centers is further provided. As shown in FIG. 12, the system may include an active data center 121 and a standby data center 123.

At least one load balancing device configured to receive and forward service traffic is deployed in active data center 121. Standby data center 123 has a mutually redundant relationship with active data center 121, and at least one load balancing device is deployed in standby data center 123. In the case of switching from the active data center to the standby data center, service traffic is guided to the standby data center, and the load balancing device in the standby data center allocates the service traffic.

Specifically, the active data center and the standby data center described here may be two data centers (IDC rooms) in the same region. For example, a data center with a high priority in a data center cluster may be set as the active data center, and a data center with a low priority may be set as the standby data center. After switching is performed from the active data center to the standby data center, data in the active data center may be migrated to the standby data center. A storage device in the active data center communicates with a storage device in the standby data center, and data in the storage device in the active data center is synchronized to the storage device in the standby data center in real time. The standby data center creates a corresponding service network and a service server according to network information of the service server, network device configuration information, and service server information. Service traffic transmitted to the active data center is guided to the standby data center. Specifically, the load balancing device in the active data center may perform address and port conversion on service traffic sent by a user, and send the service traffic sent by the user to the load balancing device in the standby data center. The load balancing device may forward the service traffic to a target server according to a load balancing algorithm.

For example, the foregoing embodiments of the present disclosure are described by taking the application scenario shown in FIG. 3 as an example. For an Internet service in an IDC, an IP address of the Internet service in the IDC in the same region may be simultaneously announced (published by BGP routing) to have different “priorities” in two rooms. As shown in FIG. 3, a BGP route announcement of an SLB router of a site A is X.Y.Z.0/24. A BGP route announcement of an SLB router of a site B is X.Y.Z.0/25, X.Y.Z.128/25. A data center with a high priority is an active data center, which may be the SLB router of the site A in FIG. 3. A data center with a low priority is a standby data center, which may be the SLB router of the site B in FIG. 3. A mutually redundant relationship is implemented between the active data center and the standby data center. In a normal case, ½ VIPs with high priorities run in two different IDCs. In the case of switching from the active data center to the standby data center, service traffic transmitted to the active data center can be guided to the standby data center. A load balancing device in the standby data center allocates the received service traffic to a corresponding service server by using a load balancing algorithm.

In the solution disclosed in some embodiments of the present disclosure, an active data center and a standby data center have a mutually redundant relationship. At least one load balancing device is deployed in each of the active data center and the standby data center. In the case of switching from the active data center to the standby data center, service traffic transmitted to the active data center can be guided to the standby data center in the solution, such that the load balancing device in the standby data center allocates the service traffic, thus implementing migration of the service traffic.

It is noted that the active data center and the standby data center have a mutually redundant relationship, and data in the active data center can be synchronized to the standby data center in real time. When the active data center fails and becomes unavailable, switching can be performed from the active data center to the standby data center, such that the load balancing device in the standby data center allocates the traffic. Therefore, by means of the solution provided in the embodiments of the present disclosure, when a failure, such as a catastrophic failure occurs in a data center (e.g., an active data center), service traffic can be quickly migrated to another data center (e.g., a standby data center), and service functions can be restored to the another data center within a short time. Thus, corresponding waiting time of users can be reduced, network data processing capability can be enhanced, and flexibility and availability of the network and improved.

Accordingly, the solution of the foregoing embodiments provided in the present disclosure can tackle the technical problem in the conventional art that an Internet service in an IDC is interrupted when a data center fails and becomes unavailable.

In the foregoing embodiments of the present disclosure, the apparatus may further include an intermediate router 131, as shown in FIG. 13.

Intermediate router 131 is configured to monitor the active data center, and perform switching from the active data center to the standby data center if detecting that the active data center is in an unavailable state.

Specifically, the unavailable state can include at least one of the following states: a power-off state, a failed state, an intrusion state, and an overflow state.

In an optional solution, when detecting that the active data center is unavailable, the intermediate router may deliver a data center switching instruction. The active data center may lower its own priority after the storage device in the active data center receives the data center switching instruction, and the standby data center may raise its own priority after the storage device in the standby data center receives the data center switching instruction, such that switching is performed from the active data center to the standby data center.

For example, the foregoing embodiments of the present disclosure are described by still taking the application scenario shown in FIG. 3 as an example. For an Internet service in an IDC, a data center usually having a “high priority” (which may be the SLB router of the site A in FIG. 3) provides a service for a client. When the data center becomes unavailable, the border routing protocol BGP can converge quickly (e.g., within 180 seconds in the worst case, and within 30 seconds in a normal case). In this case, a data center having a “low priority” keeps serving the user in place of the failed data center (having a “high priority”). When a single data center is unavailable, for example, when the active data center is unavailable or fails, fail-over migration may be performed to copy data in the active data center to the standby data center, and switching is performed from the active data center to the standby data center, such that the standby data center allocates service traffic.

By means of the foregoing solution, when the active data center is unavailable, switching is performed from the active data center to the standby data center. Therefore, switching is performed from the active data center to the standby data center when the active data center fails and becomes unavailable, such that the standby data center provides services for users.

In the foregoing embodiments of the present disclosure, active data center 121 can be further configured to synchronize data to the standby data center in real time before switching is performed from the active data center to the standby data center.

Specifically, the active data center and the standby data center have a mutually redundant relationship. Data in the active data center can be copied to the standby data center in real time. Therefore, when the active data center (or the standby data center) fails, the standby data center (or the active data center) can take over an application within a short time, thus ensuring continuity of the application.

In an optional solution, to ensure that the load balancing device in the standby data center can allocate traffic transmitted to the active data center after switching is performed from the active data center to the standby data center, data synchronization between the active data center and the standby data center is to be ensured. The storage device in the active data center may communicate with the storage device in the standby data center, and data is synchronized in real time between the active data center and the standby data center, thus ensuring data synchronization between the two data centers.

For example, the foregoing embodiments of the present disclosure are described by still taking the application scenario shown in FIG. 3 as an example. An active data center (which may be the SLB router of the site A in FIG. 3) may communicate with a standby data center (which may be the SLB router of the site B in FIG. 3), and data in the two storage devices is synchronized in real time. Moreover, in the case of switching from the active data center to the standby data center, the data in the active data center is copied to the standby data center, thus ensuring data synchronization between the standby data center and the active data center.

By means of the foregoing solution, data can be synchronized between the active data center and the standby data center in real time. Therefore, after switching is performed from the active data center to the standby data center, the load balancing device in the standby data center can allocate service traffic transmitted to the active data center, thus ensuring the availability of a service of a user.

In the above embodiments of the present disclosure, the load balancing device can include one or more types as follows: a layer-3 load balancing device, a layer-4 load balancing device, a layer-5 load balancing device, a layer-6 load balancing device, and a layer-7 load balancing device.

Specifically, the layer-3 load balancing device in the foregoing step is based on an IP address. A request can be received by using a virtual IP address, and the request is then allocated to a real IP address. The layer-4 load balancing device is based on an IP address and port. A request can be received by using a virtual IP address and port, and the request is then allocated to a real server. The layer-7 load balancing device is based on application layer information such as a URL. A request can be received by using a virtual URL address or host name, and the request is then allocated to a real server.

In an optional solution, the layer-4 load balancing device can publish a layer-3 IP address (VIP) and add a layer-4 port number to determine traffic on which load balancing processing is to be performed. The traffic on which load balancing processing is to be performed is forwarded to a back-end server, and identification information of the back-end server to which the traffic is forwarded is stored, thus ensuring that all subsequent traffic is processed by the same server.

In another optional solution, based on the layer-4 load balancing device, the layer-7 load balancing device may further be provided with application layer features such as a URL address, an HTTP protocol, Cookie, or other information to determine the traffic on which load balancing processing is to be performed.

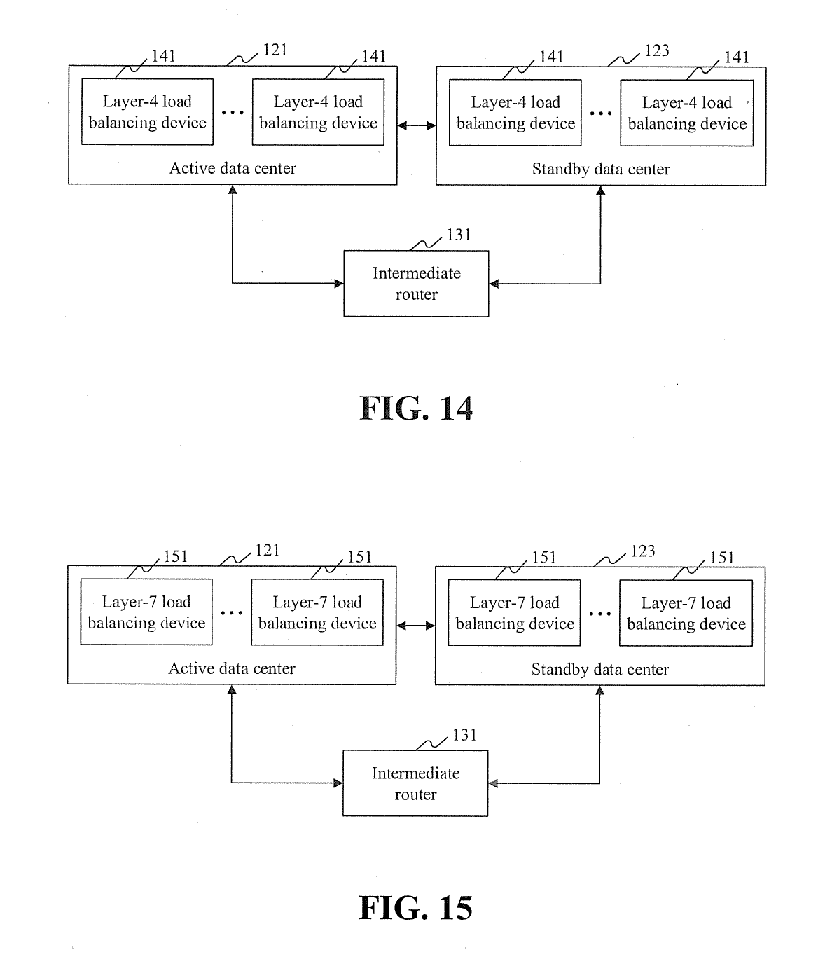

In the foregoing embodiments of the present disclosure, the load balancing device can include a layer-4 load balancing device 141, as shown in FIG. 14.

The layer-4 load balancing device 141 is configured to select a target server according to a scheduling strategy, and allocate the service traffic to the target server through an LVS cluster.

Specifically, the scheduling strategy described here may include, but is not limited to, a polling manner, a URL scheduling strategy, a URL hash scheduling strategy, or a consistency hash scheduling strategy. The layer-4 load balancing device can send data traffic to an LVS cluster through ECMP routing, and the LVS cluster forwards the data traffic to the target server.

In an optional solution, the layer-4 load balancing device is connected to a plurality of servers. After a request packet sent by a user of a first network is received, address (including a source address and a destination address) and port conversion may be performed on the request packet to generate a request packet of a second network. A target server is determined from among the plurality of servers by using a scheduling strategy, and the LVS cluster sends the request packet of the second network to the corresponding target server. The target server may return, by using a source address mapping manner, a returned response packet of the second network to the layer-4 load balancing device. After receiving the response packet of the second network, the layer-4 load balancing device performs address and port conversion on the response packet of the second network to generate a response packet of the first network, and returns the response packet of the first network to the user.

Here, it is noted that, the request packet of the first network and the response packet of the first network can be packets of the same network type. The request packet of the second network and the response packet of the second network can be packets of the same network type.

For example, the foregoing embodiments of the present disclosure are described by taking the application scenario shown in FIG. 4 as an example. For a layer-4 user in a public cloud with SLB, in a layer-4 area, a VM represents a corresponding user instance. SLB in a data center can guide service traffic by performing health check. In a normal state, one piece of monitored traffic is forwarded by only one data center. In the case of switching from an active data center (which may be a site A in FIG. 4) to a standby data center (which may be a site B in FIG. 4), a layer-4 load balancing device in the standby data center selects a target server according to a scheduling strategy, and allocates service traffic to the target server through an LVS cluster.

By means of the foregoing solution, a load balancing device can determine a target server by using a scheduling strategy, and allocate traffic to the target server through an LVS cluster. Thus, availability of a user service can be ensured, and the stability of a load balancing service can be improved.

In the foregoing embodiments of the present disclosure, load balancing device can include a layer-7 load balancing device 151 as shown in FIG. 15.

The layer-7 load balancing device 151 is configured to select a target server according to a scheduling strategy, and to allocate the service traffic to the target server through an LVS cluster.

Specifically, the scheduling strategy described here may be the same as or different from the scheduling strategy of the layer-4 load balancing device. The layer-7 load balancing device can send data traffic to an LVS cluster through ECMP routing, and the LVS cluster forwards the data traffic to the target server.

In an optional solution, the layer-7 load balancing device is connected to a plurality of servers. After receiving a request packet sent by a user of a first network, the layer-7 load balancing device can establish a connection with a client terminal through a proxy server to receive a packet of real application layer content sent by the client terminal, and determine a target server according to a specific field (e.g., a header of an HTTP packet) in the packet and according to a scheduling strategy.

Here, it is noted that the load balancing device may be more similar to a proxy server in this case. The load balancing device can establish a TCP connection respectively with a front-end client terminal and a back-end server. Therefore, the layer-7 load balancing device may have a higher requirement and a lower processing capability than the layer-4 load balancing device.

For example, the foregoing embodiments of the present disclosure are described by taking the application scenario shown in FIG. 5 as an example. For a layer-7 user in a public cloud with SLB, in a layer-4 area, a proxy server represents a proxy component of the SLB. SLB in a data center can guide service traffic by performing health check. In a normal state, one piece of monitored traffic is forwarded by only one data center. In the case of switching from an active data center (which may be a site A in FIG. 5) to a standby data center (which may be a site B in FIG. 5), a layer-7 load balancing device in the standby data center selects a target server according to a scheduling strategy, and allocates service traffic to the target server through an LVS cluster.

By means of the foregoing solution, a load balancing device can determine a target server by using a scheduling strategy, and allocate traffic to the target server through an LVS cluster. Thus, availability of a user service can be ensured, a failure in an application layer can be avoided, and the stability of a load balancing service can be improved.

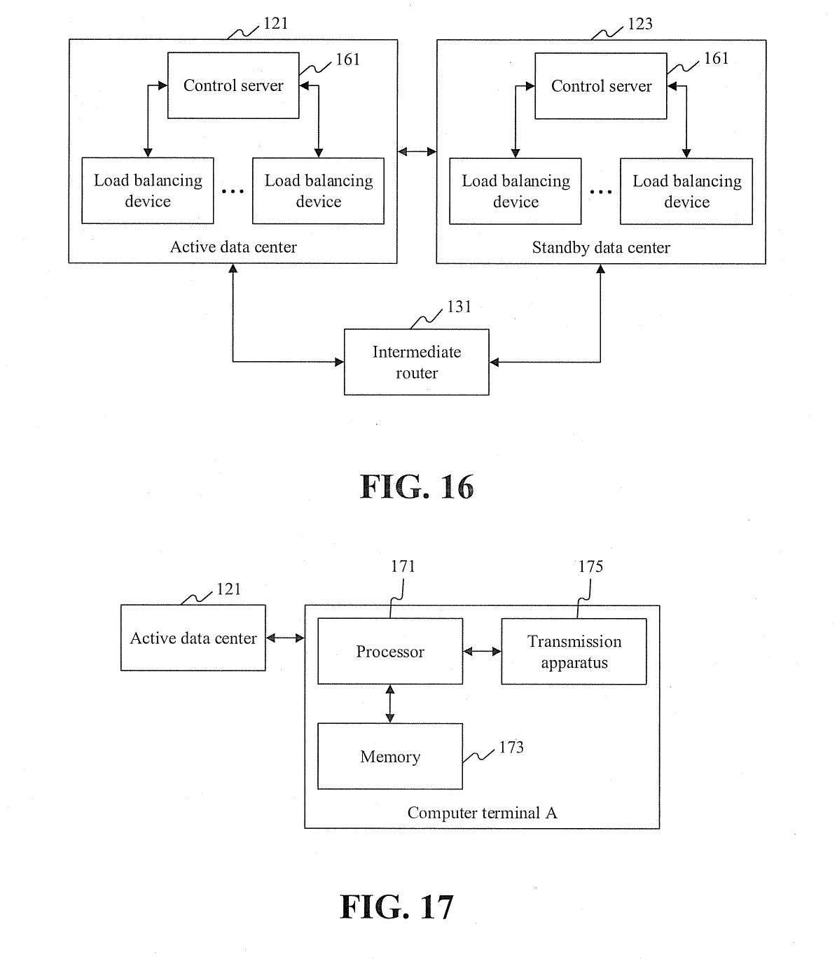

In the foregoing embodiments of the present disclosure, standby data center 121 can further include a control server 161, as shown in FIG. 16.

Control server 161 is connected to the layer-4 load balancing device and the layer-7 load balancing device respectively to configure a scheduling strategy.

In the foregoing embodiments of the present disclosure, when the load balancing device includes a layer-4 load balancing device, the scheduling strategy may include determining the target server by checking online states or resource usage of a plurality of back-end service servers. Control server 161 can be further configured that, when any data center is allowed to access each back-end service group, cross traffic may be generated when the LVS cluster forwards the service traffic in the plurality of back-end service servers.

In an optional solution, to ensure that more service requests can be allocated to a server that processes fewer service requests or that a failed server can stop receiving a service request until the failure is fixed, an optimal target server can be determined by performing the following action. The action may include determining whether there is a failed server in a plurality of back-end service servers by checking online states of the service servers. The action may also include determining the number of service requests processed by each service server by checking the resource usage of the plurality of back-end service servers.

For example, the foregoing embodiments of the present disclosure are described by still taking the application scenario shown in “as an example. For a layer-4 user in a public cloud with SLB, in a layer-4 area, a VM may represent a corresponding user instance, and all instances are visible to all data centers. Therefore, cross traffic may occur when the LVS cluster forwards the service traffic.

By means of the foregoing solution, a target server can be determined by checking online states or resource usage of a plurality of back-end service servers, such that the plurality of back-end service servers can accomplish tasks together. Thus, existing bottlenecks of uneven distribution of network load and long response time due to data traffic congestion can be eliminated or avoided.

In the foregoing embodiments of the present disclosure, when the load balancing device includes the layer-7 load balancing device, the scheduling strategy can include determining the target server by checking online states or resource usage of a plurality of back-end service servers. Control server 161 can be further configured that, when only the current standby data center is allowed to access a plurality of back-end service groups, each LVS in the LVS cluster is allocated with at least one back-end service server that has a connection relationship and the allocated back-end service servers may differ across the LVSs, such that no cross traffic is generated when the plurality of back-end service servers forward the service traffic.

In an optional solution, to ensure that more service requests can be allocated to a server that processes fewer service requests or that a failed server can stop receiving a service request until the failure is fixed, an optimal target server can be determined by performing the following action. The action may include determining whether there is a failed server in a plurality of back-end service servers by checking online states of the service servers. The action may also include by determining the number of service requests processed by each service server by checking the resource usage of the plurality of back-end service servers.

For example, the foregoing embodiments of the present disclosure are described by still taking the application scenario shown in FIG. 5 as an example. For a layer-7 user in a public cloud with SLB, in a layer-4 area, a proxy server represents a proxy component of the SLB, and all instances thereof are visible to all data centers. Therefore, cross traffic may occur when the LVS cluster forwards the service traffic, and a proxy component in a data center is only visible to SLB in the current data center. As such, it is avoided that traffic of the layer-7 user crosses into the L4 area to increase an unnecessary delay.

By means of the foregoing solution, a target server can be determined by checking online states or resource usage of a plurality of back-end service servers, such that the plurality of back-end service servers can accomplish tasks together. Thus, existing bottlenecks of uneven distribution of network load and long response time due to data traffic congestion can be eliminated or avoided.

In the foregoing embodiments of the present disclosure, when the load balancing device includes the layer-7 load balancing device, control server 161 can further configure an RDS database corresponding to the current data center, such that no cross traffic is generated when the RDS database stores the service traffic in the case in which only the current standby data center is allowed to access the RDS database.

For example, the foregoing embodiments of the present disclosure are described by taking the application scenario shown in FIG. 5 as an example. For a user of an RDS, in a layer-4 area, a VM represents a database of the RDS. The RDS is sensitive to a delay, and therefore an ID of a data center in which the database of the RDS is located is designated during configuration, such that an SLB configuration system ensures that the ID of the data center is only visible to an SLB in the current data center. Thus, cross traffic can be avoided and an unnecessary delay can be reduced.

Some embodiments of the present disclosure may provide a computer terminal. The computer terminal may be any computer terminal device in a computer terminal group. Optionally, in these embodiments, the computer terminal may also be replaced with a terminal device such as a mobile terminal.

Optionally, in these embodiments, the computer terminal may be located in at least one of a plurality of network devices in a computer network.

In these embodiments, the computer terminal may execute program codes to cause the following steps in a method for controlling service traffic between data centers. An active data center and a standby data center that have a mutually redundant relationship are provided. At least one load balancing device is deployed in each of the active data center and the standby data center. In the case of switching from the active data center to the standby data center, service traffic transmitted to the active data center is guided to the standby data center, and the load balancing device in the standby data center allocates the service traffic.

Optionally, FIG. 17 is a block diagram of an exemplary computer terminal according to some embodiments of the present disclosure. As shown in FIG. 17, computer terminal A can include one or more processors 171 (only one is shown in the figure), a memory 173, and a transmission apparatus 175.

Memory 173 may be configured to store software programs and modules, e.g., program instructions or a module corresponding to the method and apparatus for controlling service traffic between data centers in the embodiments of the present disclosure. Processor 171 executes software programs and modules stored in the memory to perform various functional applications and data processing, for example, to implement the method for controlling service traffic between data centers. Memory 173 may include a high-speed random access memory, and may further include a non-volatile memory, e.g., one or more magnetic storage apparatuses, flash memories, or other non-volatile solid-state memories. In some examples, memory 173 may further include memories remotely disposed with respect to the processor, and the remote memories may be connected to the terminal A through a network. The example of the network includes, but not limited to, the Internet, an Intranet, a local area network, a mobile telecommunications network, and their combinations.

Processor 171 may call, by using the transmission apparatus, information and an application program stored in the memory to perform the following steps. An active data center and a standby data center that have a mutually redundant relationship is provided. At least one load balancing device is deployed in each of the active data center and the standby data center. In the case of switching from the active data center to the standby data center, service traffic transmitted to the active data center is guided to the standby data center, and the load balancing device in the standby data center allocates the service traffic.

Optionally, processor 171 may further execute a program code to cause monitoring the active data center by using an intermediate router, and if it is detected that the active data center is in an unavailable state, performing switching from the active data center to the standby data center.

Optionally, processor 171 may further execute a program code to cause the determination of an unavailable state that can include at least one of the following states: a power-off state, a failed state, an intrusion state, and an overflow state.

Optionally, processor 171 may further execute a program code to cause setting a data center having a high priority as the active data center, and setting a data center having a low priority as the standby data center, wherein before switching is performed from the active data center to the standby data center. The method can further include synchronizing data between the active data center and the standby data center in real time.

Optionally, processor 171 may further execute a program code to enable a load balancing device that can include one or more types as follows: a layer-3 load balancing device, a layer-4 load balancing device, a layer-5 load balancing device, a layer-6 load balancing device, and a layer-7 load balancing device.

Optionally, processor 171 may further execute program codes to cause, when the load balancing device includes a layer-4 load balancing device, selecting, by a layer-4 load balancing device in the standby data center, a target server according to a scheduling strategy, and allocating, by the layer-4 load balancing device, service traffic to the target server through an LVS cluster.

Optionally, processor 171 may further execute a program code to cause the provision of a scheduling strategy that can include determining the target server by checking online states or resource usage of a plurality of back-end service servers, wherein a control server in the standby data center configures a scheduling strategy. With the scheduling strategy, when any data center is allowed to access each back-end service group, cross traffic may be generated when the LVS cluster forwards the service traffic in the plurality of back-end service servers.

Optionally, processor 171 may further execute program codes to cause, when the load balancing device includes a layer-7 load balancing device, selecting, by the layer-7 load balancing device in the standby data center, a target server according to a scheduling strategy, and allocating, by the layer-7 load balancing device, service traffic to the target server through an LVS cluster.

Optionally, processor 171 may further execute a program code to cause the provision of a scheduling strategy that can include determining the target server by checking online states or resource usage of a plurality of back-end service servers, wherein a control server in the standby data center configures a scheduling strategy. With the scheduling strategy, when only the current standby data center is allowed to access a plurality of back-end service groups, each LVS in the LVS cluster is allocated with at least one back-end service server that has a connection relationship and the allocated back-end service servers may differ across the LVSs, such that no cross traffic is generated when the plurality of back-end service servers forward the service traffic.

Optionally, processor 171 may further execute a program code to cause configuring, by a control server in a standby data center, an RDS database corresponding to the current data center, such that no cross traffic is generated when the RDS database stores the service traffic in the case in which only the current standby data center is allowed to access the RDS database.

By means of the embodiments of the present disclosure, an active data center and a standby data center have a mutually redundant relationship. At least one load balancing device is deployed in each of the active data center and the standby data center In the case of switching from the active data center to the standby data center, service traffic transmitted to the active data center can be guided to the standby data center in the solution, such that the load balancing device in the standby data center allocates the service traffic, thus implementing migration of the service traffic. The technical problem in the conventional art that an Internet service in an IDC is interrupted when a data center fails and becomes unavailable can be tackled.

It can be understood that the structure shown in FIG. 17 is merely schematic. The computer terminal may also include a terminal device such as a smart phone (for example, an Android phone, and an iOS phone), a tablet computer, a palmtop computer, a Mobile Internet Device (MID), and a PAD. FIG. 17 is not intended to limit the structure of the above electronic apparatus. For example, computer terminal A may further include more or fewer components (such as a network interface and a display apparatus) than those shown in FIG. 17, or have a configuration different from that shown in FIG. 17.

It can be understood that all or a part of steps in various methods of the above embodiments can be implemented by a program instructing hardware related to a terminal device. The program may be stored in a computer readable storage medium, and the storage medium may include: a flash memory, a ROM, a RAM, a magnetic disk, or an optical disc.

Some embodiments of the present disclosure further provide a storage medium. Optionally, in these embodiments, the storage medium may be configured to store program codes executed to perform a method for controlling service traffic between data centers provided embodiments disclosed herein.

Optionally, in these embodiments, the storage medium may be located in any computer terminal in a computer terminal group in a computer network, or located in any mobile terminal in a mobile terminal group.

Optionally, in these embodiments, the storage medium can be configured to store program codes for performing the following. An active data center and a standby data center that have a mutually redundant relationship is provided. At least one load balancing device is deployed in each of the active data center and the standby data center. In the case of switching from the active data center to the standby data center, service traffic transmitted to the active data center is guided to the standby data center, and the load balancing device in the standby data center allocates the service traffic.

Optionally, in these embodiments, the storage medium can be configured to store a program code for performing the following. The active data center is monitored by using an intermediate router. If it is detected that the active data center is in an unavailable state, switching from the active data center to the standby data center is performed.

Optionally, in these embodiments, the storage medium can be configured to store a program code for determining an unavailable state that can include at least one of the following states: a power-off state, a failed state, an intrusion state, and an overflow state.

Optionally, in these embodiments, the storage medium can be configured to store a program code for setting a data center having a high priority as the active data center, and setting a data center having a low priority as the standby data center, wherein before switching is performed from the active data center to the standby data center. The storage medium can be configured to further synchronizing data between the active data center and the standby data center in real time.

Optionally, in these embodiments, the storage medium can be configured to store a program code for enabling a load balancing device that can include one or more types as follows: a layer-3 load balancing device, a layer-4 load balancing device, a layer-5 load balancing device, a layer-6 load balancing device, and a layer-7 load balancing device.

Optionally, in these embodiments, the storage medium can be configured to store program codes for, when the load balancing device includes a layer-4 load balancing device, selecting, by a layer-4 load balancing device in the standby data center, a target server according to a scheduling strategy, and allocating, by the layer-4 load balancing device, service traffic to the target server through an LVS cluster.

Optionally, in these embodiments, the storage medium can be configured to store a program code for providing a scheduling strategy that can include determining the target server by checking online states or resource usage of a plurality of back-end service servers, wherein a control server in the standby data center configures a scheduling strategy. With the scheduling strategy, when any data center is allowed to access each back-end service group, cross traffic may be generated when the LVS cluster forwards the service traffic in the plurality of back-end service servers.

Optionally, in these embodiments, the storage medium can be configured to store program codes for, when the load balancing device includes a layer-7 load balancing device, selecting, by the layer-7 load balancing device in the standby data center, a target server according to a scheduling strategy, and allocating, by the layer-7 load balancing device, service traffic to the target server through an LVS cluster.

Optionally, in these embodiments, the storage medium can be configured to store a program code for providing a scheduling strategy that can include determining the target server by checking online states or resource usage of a plurality of back-end service servers, wherein a control server in the standby data center configures a scheduling strategy. With the scheduling strategy, when only the current standby data center is allowed to access a plurality of back-end service groups, each LVS in the LVS cluster is allocated with at least one back-end service server that has a connection relationship and the allocated back-end service servers may differ across the LVSs, such that no cross traffic is generated when the plurality of back-end service servers forward the service traffic.

Optionally, in these embodiments, the storage medium can be configured to store a program code for configuring, by a control server in a standby data center, an RDS database corresponding to the current data center, such that no cross traffic is generated when the RDS database stores the service traffic in the case in which only the current standby data center is allowed to access the RDS database.

In the above embodiments of the present disclosure, the descriptions of the embodiments may have different emphases, and for parts that are not described or are not described in detail in certain embodiments or examples, reference may be made to related descriptions of other embodiments.

In the several embodiments provided in the present disclosure, it is understood that, the disclosed technical content may be implemented in other manners. For example, the apparatus embodiments described in the foregoing are merely schematic. The division of units can represent merely division of logic functions. There may be other division manners during actual implementation. For example, a plurality of units or components may be combined or may be integrated into another system, or some features may be omitted, disabled, or not set to perform. On the other hand, the shown or discussed coupling or direct coupling or communication connection between them may be implemented by using some interfaces, and indirect coupling or communication connection between units or modules may be in an electrical form or other forms.

Units described as separated parts may or may not be physically separated, parts shown as units may or may not be physical units, and they may be located at the same place, or be distributed to a plurality of network units. An embodiment may be implemented by selecting a part of or all units therein according to actual requirements.

In addition, various functional units in the embodiments of the present disclosure may be integrated into one processing unit. Each unit may also exist alone physically, and two or more units may also be integrated into one unit. The integrated unit may be implemented in the form of hardware, and may also be implemented in the form of a software functional unit.

The integrated unit, if implemented in the form of a software functional unit and sold or used as an independent product, may be stored in a computer readable storage medium. Based on such an understanding, the technical solutions of the present disclosure may be implemented in the form of a software product. The computer software product may be stored in a storage medium, and include instructions for instructing a computer device (which may be a personal computer, a server, a network device or the like) to perform all or part of the steps of the methods described in the embodiments of the present disclosure. The storage medium includes: a USB flash drive, a ROM, a RAM, a portable hard disk, a magnetic disk, an optical disc, or other non-transitory media that may store program code.

Those described above are merely some implementations of the present disclosure. It is noted that those of ordinary skill in the art may further obtain variations and improvements without departing from the principle of the present disclosure, and the variations and improvements all fall within the protection scope of the present disclosure.

1. A method for controlling service traffic between an active data center and a standby data center, the standby data center deploying at least one load balancing device, the method comprising:
performing a switching from the active data center to the standby data center; and
guiding service traffic transmitted to the active data center to the standby data center, wherein the guided service traffic is allocated by the at least one load balancing device in the standby data center.

2. The method according to claim 1, wherein before performing the switching from the active data center to the standby data center, the method further comprising:
monitoring the active data center, and
detecting that the active data center is in an unavailable state.

3. The method according to claim 2, wherein the unavailable state comprises at least one of the following states: a power-off state, a failed state, an intrusion state, and an overflow state.

4. The method according to claim 1, wherein, before performing the switching:
the active data center has a higher priority and the standby data center has a lower priority; and
data is synchronized between the active data center and the standby data center.

5. The method according to claim 1, wherein at least one of the deployed load balancing devices comprises at least one of the following: a layer-3 load balancing device, a layer-4 load balancing device, a layer-5 load balancing device, a layer-6 load balancing device, or a layer-7 load balancing device.

6. The method according to claim 5, wherein the guided service traffic is allocated by the layer-4 balancing device in the standby data center includes a selection of a target server according to a scheduling strategy by the layer-4 balancing device and an allocation of the service traffic to the target server through an LVS cluster.

7. The method according to claim 6, wherein the scheduling strategy includes the target server being determined by checking online states or resource usage of a plurality of back-end service servers, and when any data center is allowed to access each of the plurality of back-end service servers, cross traffic is generated when the LVS cluster forwards the service traffic in the plurality of back-end service servers.

8. The method according to claim 5, wherein the guided service traffic is allocated by the layer-7 balancing device in the standby data center includes a selection of a target server according to a scheduling strategy by the layer-7 balancing device and an allocation of the service traffic to the target server through an LVS cluster.

9. The method according to claim 8, wherein the scheduling strategy includes the target server being determined by checking online states or resource usage of a plurality of back-end service servers, and when only the current standby data center is allowed to access a plurality of back-end service servers, each LVS in the LVS cluster is allocated at least one back-end service server having a connection relationship and the allocated back-end service servers differ across the LVSs, such that no cross traffic is generated when the plurality of back-end service servers forward the service traffic.

10. The method according to claim 5, wherein the standby data center configures an RDS database, such that no cross traffic is generated when the RDS database stores the service traffic under a condition that only the standby data center is allowed to access the RDS database.

11. A system for controlling service traffic between data centers, comprising:
an active data center having at least one load balancing device configured to receive and forward service traffic; and
a standby data center having at least one load balancing device,
wherein the active data center and the standby data center are configured to be switchable, and
wherein service traffic is guided to the standby data center in response to a switch from the active data center to the standby data center, and the at least one load balancing device in the standby data center allocates the service traffic.

12. The system according to claim 11, further comprising:
an intermediate router configured to monitor the active data center, and to perform the switching from the active data center to the standby data center in response to detecting that the active data center is in an unavailable state.

13. The system according to claim 12, wherein the unavailable state comprises at least one of the following states: a power-off state, a failed state, an intrusion state, and an overflow state.

14. The system according to claim 11, wherein at least one of the load balancing devices comprises at least one of the following: a layer-3 load balancing device, a layer-4 load balancing device, a layer-5 load balancing device, a layer-6 load balancing device, and a layer-7 load balancing device.

15. The system according to claim 14, wherein the at least one of the load balancing devices comprises:
a layer-4 load balancing device configured to select a target server according to a scheduling strategy, and to allocate the service traffic to the target server through an LVS cluster.

16. The system according to claim 14, wherein the at least one of the load balancing devices comprises:
a layer-7 load balancing device configured to select a target server according to a scheduling strategy, and to allocate the service traffic to the target server through an LVS cluster.

17. The system according to claim 14, wherein the standby data center further comprises:
a control server configuring a scheduling strategy and connected to a layer-4 load balancing device, and a layer-7 load balancing device.

18.-22. (canceled)

23. A non-transitory computer-readable storage medium storing a set of instructions that is executable by one or more processors of an electronic device to cause the electronic device to perform a method for controlling service traffic between an active data center and a standby data center, the standby data center deploying at least one load balancing device, the method comprising:
performing a switching from the active data center to the standby data center; and
guiding service traffic transmitted to the active data center to the standby data center, wherein the guided service traffic is allocated by the at least one load balancing device in the standby data center.
